(19) United States
(12) Patent Application Publication
(10) Pub. No.: US 2007/0187496 A1
(43) Pub. Date: Aug. 16, 2007

(54) Inventory tracking system and method

(76) Inventors: Scott P. Andersen, Loveland, OH (US); Vernon M. Peeler, Hopkinsville, KY (US); Subramanian Nambi, Memphis, TN (US)

Correspondence Address: INTERNATIONAL PAPER COMPANY, 6285 TRI-RIDGE BOULEVARD, LOVELAND, OH, 45140, US

(21) Appl. No.: 11/351,743

(22) Filed: Feb. 10, 2006

(51) Int. Cl. G06Q 30/00

(52) U.S. Cl. 235/385

(57) ABSTRACT

A method of tracking inventory movement using a material handling device is provided. The method includes utilizing automatic identification objects positioned at predetermined locations about a perimeter of a zone, each automatic identification object having zone determining information that is readable by a reader. The zone determining information from at least one automatic identification object is obtained using a reader that is carried by the material handling device. Zone determining information is obtained from a source different from the at least one automatic identification object. The zone determining information obtained from the at least one automatic identification object and the source different from the at least one automatic identification object is processed to identify that the material handling device is moving into the zone.

### TECHNICAL FIELD

The present application relates to inventory tracking processes, systems and devices.

### BACKGROUND

Radio frequency identification (“RFID”) technology has been used for wireless (i.e., non-contact, non-line of sight) automatic identification. A RFID system typically includes a RFID transponder, which is sometimes referred to as an inlet, inlay or tag, and a RFID reader. The transponder typically includes a radio frequency integrated circuit (“RFIC”) and an antenna. Both the antenna and the RFIC can be positioned on a substrate. The inlet, inlay or tag includes the antenna and may also include a substrate on which the antenna is positioned.

The RFID reader utilizes an antenna and a transceiver, which includes a transmitter, a receiver, and a decoder incorporating hardware and software components. Readers can be fixed, tethered, or handheld devices, depending on the particular application. When a transponder passes through the read zone of a reader, the transponder is activated by the electromagnetic field from the reader antenna. The transceiver decodes the data sent back from the transponder and this decoded information is forwarded to a host computer for processing. Data transfer between the transponder and transceiver is wireless.

RFID systems may utilize passive, semi-passive, or active transponders. Each type of transponder may be read only or read/write capable. Passive transponders obtain operating power from the radio frequency signal of the reader that interrogates the transponder. Semi-passive and active transponders are powered by a battery, which generally results in a greater read range. Semi-passive transponders may operate on a timer and periodically transmit information to the reader. Active transponders can control their output, which allows them to activate or deactivate apparatus remotely. Active transponders can also initiate communication, whereas passive and semi-passive transponders are activated only when they are read by another device first. Multiple transponders may be located in a radio frequency field and read individually or simultaneously.

Inventory tracking systems are currently being developed that utilize RFID technology to track location of inventory. For example, it has been proposed to install readers at fixed locations, such as at a loading dock, that can read RFID tags passing nearby. When a RFID tag is read by the reader, the tracking system can determine that an item carrying that RFID tag is at a particular location (i.e., near the reader). It is desirable to provide other inventory tracking systems and methods.

### SUMMARY

In an aspect, a method of tracking inventory movement using a material handling device is provided. The method includes utilizing automatic identification objects positioned at predetermined locations about a perimeter of a zone, each automatic identification object having zone determining information that is readable by a reader. The zone determining information from at least one automatic identification object is obtained using a reader that is carried by the material handling device. Zone determining information is obtained from a source different from the at least one automatic identification object. The zone determining information obtained from the at least one automatic identification object and the source different from the at least one automatic identification object is processed to identify that the material handling device is moving into the zone.

In another aspect, a method of tracking inventory movement using a material handling device is provided. The method includes utilizing automatic identification objects positioned at predetermined locations about a perimeter of a zone, each automatic identification object having zone determining information that is readable by a reader. An inventory unit is engaged using a power-operated mechanism of the material handling device that is configured to engage the inventory unit during a transport operation whereby the inventory unit is moved from one location to a different location. The material handling device includes a reader. The zone determining information is obtained from at least one automatic identification object using the reader. Zone determining information is obtained from a source different from the at least one automatic identification object. The zone determining information obtained from the at least one automatic identification object and the source different from the at least one automatic identification object is processed to identify that the inventory unit is moving into the zone.

In another aspect, a method of tracking inventory movement using a material handling device is provided. The method includes utilizing automatic identification objects positioned at predetermined locations about perimeters of multiple zones, each automatic identification object having zone determining information that is readable by a reader. The zone determining information is obtained from at least one automatic identification object using a reader that is carried by the material handling device. Zone determining information is obtained from a source different from the at least one automatic identification object. The zone that the material handling device is moving into is determined by processing the zone determining information obtained from the at least one automatic identification object and the source different from the at least one automatic identification object.

In a fourth aspect, an inventory tracking system includes a plurality of zones. A plurality of automatic identification objects are positioned at predetermined locations about perimeters of the zones, each automatic identification object having zone determining information that is readable by a reader. A material handling device includes a reader configured to obtain zone determining information from the automatic identification objects. A processor processes zone determining information obtained by the reader and zone determining information obtained from a source different from the at least one automatic identification object to determine which of the plurality of zones the material handling device is moving into.

In a fifth aspect, a method of tracking inventory movement using a material handling device is provided. The method includes crossing a zone boundary. The zone boundary is at least partially defined by an array of automatic identification objects positioned at predetermined locations about a perimeter of a zone, each automatic identification object having zone determining information that is readable by a reader. Zone determining information is obtained from at least one of the automatic identification objects using a reader to determine that the reader is crossing the zone boundary into the zone. With the reader moving into the zone, it is determined that the reader is moving into the zone regardless of which of the automatic identification objects zone determining information is obtained from.

In yet another aspect, a method of tracking inventory using a computer system that receives information transmitted by a material handling device is provided. The method includes utilizing automatic identification objects positioned at predetermined locations about the perimeters of multiple zones, the automatic identification objects having zone determining information. A reader on the material handling device is utilized to read inventory information from an automatic identification object associated with an inventory unit. The inventory information is transmitted to the computer system. As the material handling device moves into one of the zones, zone determining information is obtained from at least one automatic identification object positioned at the predetermined location using the reader and zone determining information is obtained from a source different from the at least one automatic identification object. The zone determining information obtained from the at least one automatic identification object and the source different from the at least one automatic identification object is transmitted to the computer system to identify that the material handling device is moving into the zone.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a top, perspective view of a warehouse having zones and an embodiment of a material handling device for tracking inventory movement into the zones;

FIG. 2 is a perspective view of the material handling device of FIG. 1;

FIG. 3 is a diagrammatic, top view illustrating an embodiment of a process of tracking inventory movement into zones;

FIG. 4 is a diagrammatic, top view illustrating another embodiment of a process of tracking inventory movement into zones;

FIG. 5 is a diagrammatic, top view illustrating another embodiment of a process of tracking inventory movement between zones;

FIG. 6 is a floor layout of an embodiment of an integrated manufacturing and warehouse facility;

FIG. 7 is a perspective view of another embodiment of a material handling device for tracking inventory movement into zones; and

FIG. 8 is a diagrammatic, side view of another embodiment of a material handling device for tracking inventory movement into zones.

### DETAILED DESCRIPTION

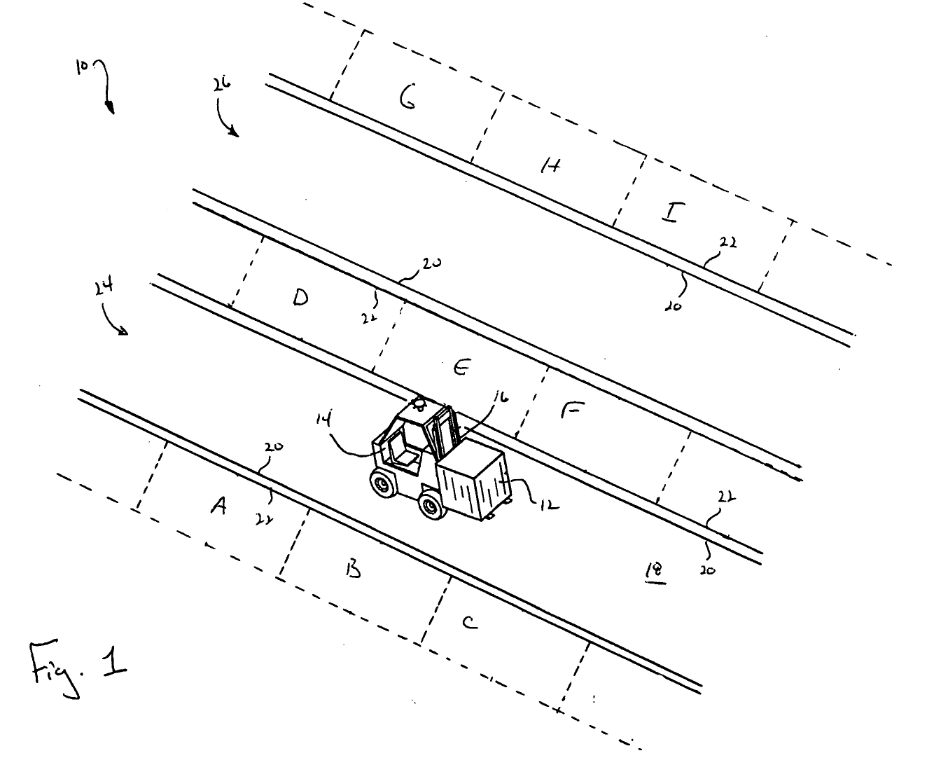

Referring to FIG. 1, a warehouse 10 or other location within a supply chain utilizes a computer-assisted system for tracking inventory movement. In particular, the system can be used to track inventory 12 movement into a particular zone of a set of zones (e.g., see zones A-I). The zones may correspond to (or correspond to a subset of) a variety of commonly used demarcation and/or classification tools for defining a warehouse layout for inventory location tracking purposes such as aisles, bins, racks, shelves, etc. Additionally, the system may be part of or interact with a warehouse management system (WMS), for example, for directed picking, directed replenishment and directed putaway of inventory.

The system utilizes a material handling device, in this example, vehicle 14 in the form of a forklift truck. Vehicle 14 is movable, e.g., manually and/or automatically and includes a manually and/or automatically power-operated material handling mechanism 16 that can be used for moving the inventory unit 12 from one position to a different position during a material handling operation. During such material handling operations, the vehicle 14 can read automatic identification objects in the form of transponders that lie beneath or embedded within the warehouse floor 18 along strips 20 and 22. In some embodiments, strips 20 and 22 may include visual indicia such as painted lines that allow a user to visually identify the strips.

In the illustrated example, each aisle 24 and 26 includes a pair of strips 20, 22 located at opposite sides of the aisle. In some embodiments, each aisle 24, 26 includes only a single strip of transponders located at a side of the aisle. As used herein, the term “transponder” refers to an electrical device that receives a specific signal and automatically transmits a reply that may include zone determining information. The term “zone” refers to an area or region set off as distinct, while the term “zone determining information” refers to information (e.g., in the form of a number, alphanumeric character, direction, heading, etc.) that can be used in identifying a particular zone.

In the illustrated embodiment, the transponders are RFID tags that include an integrated circuit connected (e.g., electrically coupled, either by direct contact or by capacitive coupling) to an antenna. The integrated circuit may include semiconductor circuits having logic, memory, RF circuitry, and may be a silicon-based chip, a polymer-based chip and the like. Data may be stored in the integrated circuit of the RFID tags (e.g., using EEPROM or SRAM, laser programming, etc.) and can be transmitted through the connected antenna.

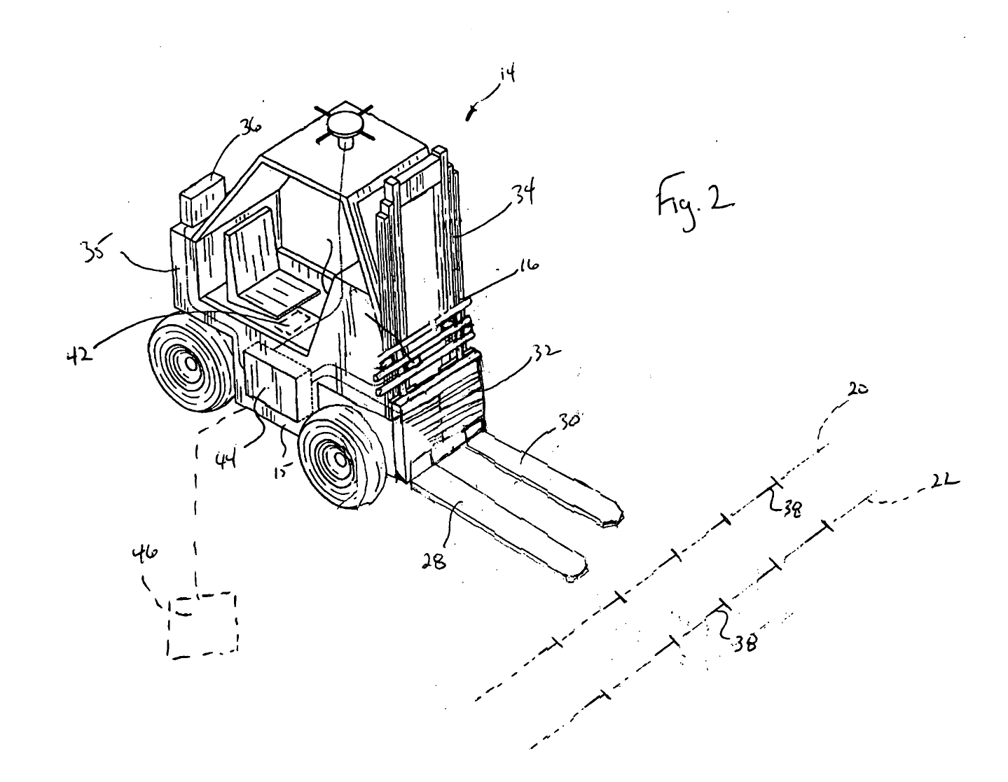

Referring to FIG. 2, vehicle 14 includes a body 35 and material handling mechanism 16 mounted thereto. Material handling mechanism 16 includes forks 28 and 30 connected to a carriage 32 that moves vertically along a mast 34. The forks 28 and 30 engage an inventory unit for moving the inventory unit from one location to a different location. While an inventory unit may be moved using the vehicle 14 for a variety of purposes, in some instances, the inventory unit may be moved to or from a zone within a warehouse, store or other facility, to or from a truck, plane, ship or train for transportation, etc., as examples.

The vehicle 14 includes a reader 36 (sometimes referred to as an interrogator) for use in activating and receiving data from RFID tags 38 embedded in the floor 18 in strips 20, 22. The reader 36 may be controlled by a processor 44 such as a microprocessor or digital signal processor, which may be carried by the vehicle 14. In other embodiments, the processor may be located externally of the vehicle 14 or may be incorporated within the reader 36. Any suitable reader may be used. Exemplary readers 36 include a Model 0101-0092-04 Sensormatic® EPC Reader is commercially available from Tyco International, Ltd and a Model “REAL” EPC Reader (MPR-3118, 3114 or 4114) is commercially available from Applied Wireless ID.

Reader 36 communicates with tags 38 via an antenna 42. Antenna 42 is mounted to receive the zone determining information from a RFID tag 38 embedded in the floor 18. Reader 36 is also capable of communicating with a computer or processor, such as on-board computer 44 or a computer or processor embedded within the reader 36. In some embodiments, reader 36 (and/or computer 44) may communicate with an off-board computer or processor 46 (represented by dotted lines). Computer 44, 46 may further process or link information obtained from the RFID tag 38 to another site, such as the Internet, for offsite monitoring. In some embodiments computer 44, 46 may be linked to a data management system, such as a warehouse management system or database, for example, that includes inventory component information in memory. In certain embodiments, computer 44, 46 may provide instructions and/or information to be transmitted to the RFID tag 38 through reader 36 and stored in the tag. Computer 44, 46 may also provide instructions and/or display information to an operator based at least in part on information received from the RFID tag 38. In embodiments including on-board computer 44, the computer 44 may provide instructions and/or display information to a user operating the vehicle 14. Information may also be provided by computer 44 to a warehouse management system which, in turn, based upon business logic or rules provides instructions and/or displays information to an operator based on information received from the tags 38 and/or other zone determining information.

Computer 44, 46 utilizes an application (e.g., a software application) that interfaces with the reader 36 to command the reader-to interrogate and obtain the RFID tag 38 zone determining information, which may be in the form of a tag identification number, and processes the zone determining information obtained from the RFID tag. An association table is stored in memory that relates the particular zone determining information to a particular strip 20, 22. The application further includes an algorithm for processing the zone determining information obtained from one or more RFID tags 38 to determine the zone the vehicle 14 is moving into.

FIG. 3, for illustrative purposes, shows a simplified example that includes two parallel strips A and B arranged in a fashion similar to that depicted by FIG. 2. As noted above, RFID tags 38 are embedded within floor 18 and arranged spaced-apart from each other (e.g., in one foot intervals) along the parallel strips A and B. Each RFID tag 38 includes a unique identification number that serves as the zone determining information. An association table saved in memory of the system is used to relate the unique identification numbers to their associated strips A and B. The application utilizes the table which maps all possible combinations of RFID tag 38 read sequences (e.g., read strip A, then read strip B) to a zone (e.g., zone C). The successful, consecutive interrogation of a first RFID tag 38 associated with strip A and a second RFID tag 38 associated with strip B using antenna 42 and reader 36 is used to automatically determine vehicle 14 movement into zone C.

In some embodiments, it is desirable that each of the RFID tags 38 include a unique identification number. Often, this unique identification number is preprogrammed into the RFID tags 38, for example, by the manufacturer of the RFID tag. Each RFID tag 38 can be interrogated to retrieve its identification number and the number can be stored into memory. Using preprogrammed RFID tags can reduce cost relative to custom programming the RFID tags with an identification number. However, in some embodiments, it may be desirable to use RFID tags that are programmed with a selected identification number (e.g., the RFID tags may be writable or rewritable). In certain implementations, it may be desirable to program multiple tags with the same identification number. Referring still to FIG. 3, each of the RFID tags 38 of strip A may be programmed with the same identification number and each of the RFID tags 38 of strip B may be programmed with a unique identification number. Other configurations are possible so long as consecutive interrogation of a first RFID tag 38 associated with strip A and a second RFID tag 38 associated with strip B can be used to determine vehicle 14 movement into zone C.

Table I below is an illustrative example of an association table for mapping consecutively obtained RFID tag identification numbers to a particular zone.

TABLE I
Exemplary Association Table
000000000000000000000036, 000000000000000000000037,MFG1,SendLocation
000000000000000000000037, 000000000000000000000036,WH1,SendLocation
00000000000000000000002E, 000000000000000000000039,WH2,SendLocation
000000000000000000000039, 00000000000000000000002E,MFG2,SendLocation
000000000000000000000031, 000000000000000000000032,IS1,
000000000000000000000061, 000000000000000000000060,IS2,
00000000000000000000002F, 000000000000000000000030,RL1,
00000000000000000000005C, 00000000000000000000005D,RL2,
000000000000000000000056, 000000000000000000000055,Trash,SendLocation

For example, reading the columns from left to right, the first column of characters may correspond to the first obtained identification number from a first strip of RFID tags, the second column of characters may correspond to the second obtained identification number from a second strip of RFID tags and the third column of characters may correspond to the associated zone.

In some instances, it maybe desirable for the application to automatically report a boundary crossing into a zone (e.g., see the rows of Table I indicating “SendLocation”). The boundary crossing or zone may be automatically reported, for example, to the computer 44, 46 for system updating and/or to a graphical interface. In other instances, it may be desirable to report the zone determined using the association table only after the occurrence of a triggering event (e.g., such as a load put down, load pick up event, etc.) for system updating and/or to a graphical interface (e.g., see the rows of Table I without the “SendLocation” command).

In an alternative embodiment represented by FIG. 4 and as noted above, only a single strip A of RFID tags 38 may be utilized in determining vehicle 14 location at a specified boundary location C. The application, for example, may contain an association table relating the RFID tag identification numbers to strip A and strip A may be mapped to multiple zones, such as two zones C and D. A heading sensor 50 (e.g., gyro, compass, accelerometer, contact or non-contact tracking technology, combinations thereof, etc.) provides zone determining information in the form of a directional input. The movement of vehicle 14 into the zone is determined based on the processing of the RFID tag identification number and the directional input using, for example, the association table. To illustrate, strip A may consist of side-by-side RFID tags 38a and 38b having identification numbers 0000 and 0001, respectively. With vehicle 14 traveling eastward in the direction of arrow 52, reader 36 interrogates RFID tag 38a due to its closer (compared to RFID tag 38b) proximity to antenna 42. Heading sensor 50 provides an indication to the processor that the vehicle is traveling in the eastward direction. This zone determining information is processed by the processor to determine that the vehicle 14 is moving into zone C.

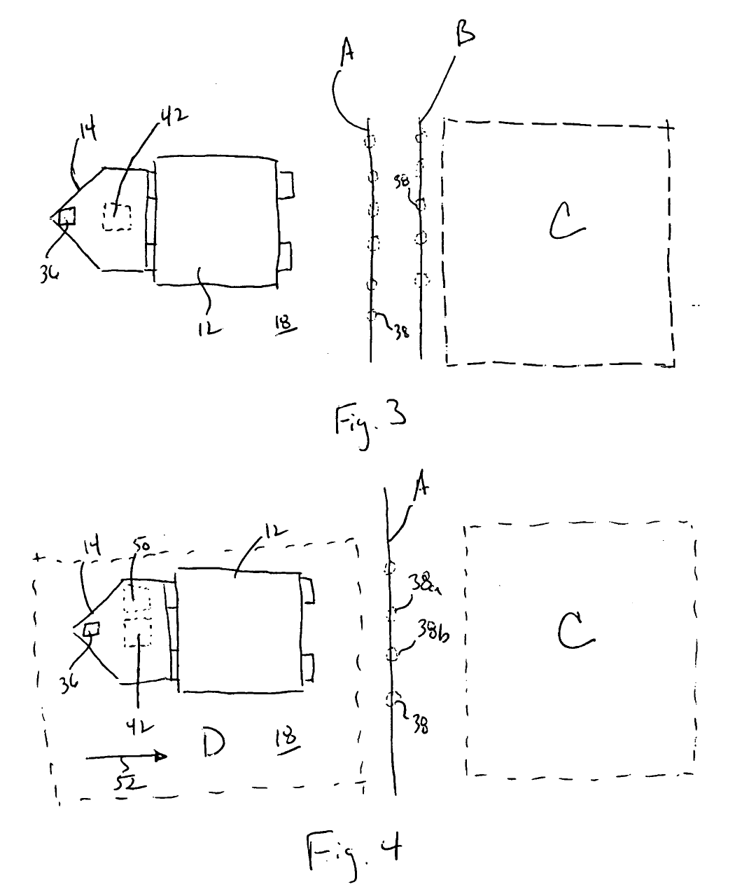

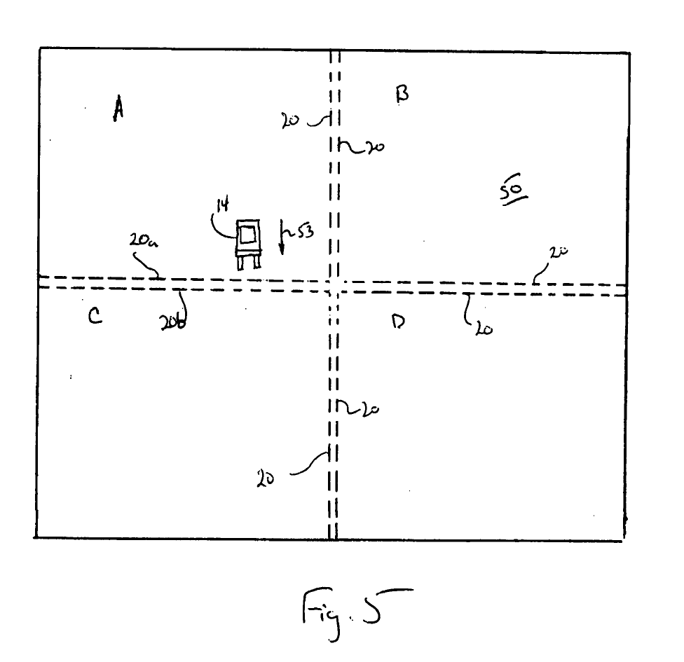

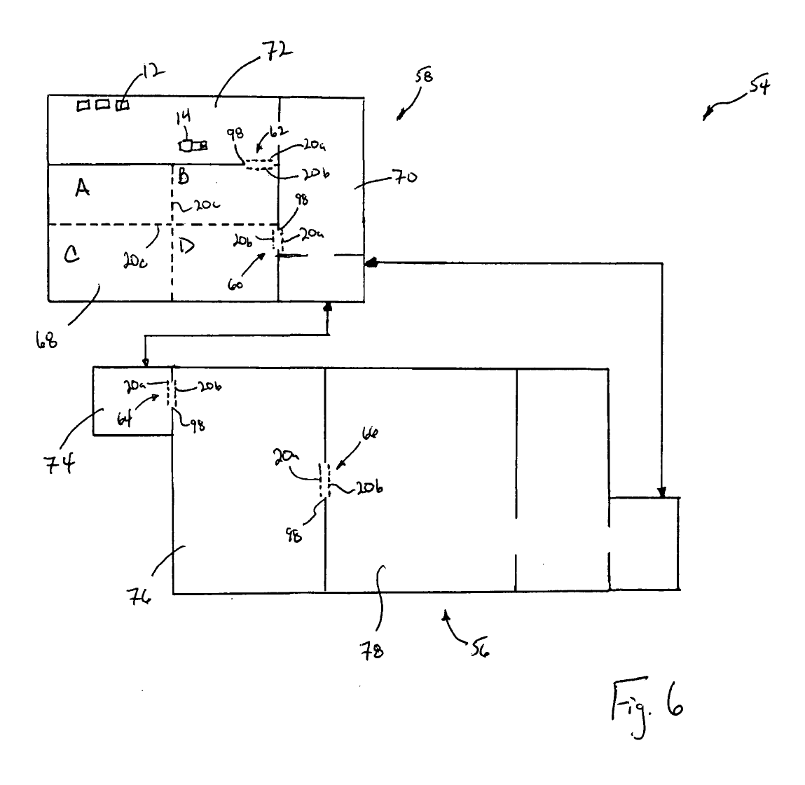

The computer-assisted system can be used to track vehicle 14 movement between zones. Referring now to FIG. 5, floor 50 is divided into zones A-D. Each zone A-D is separated from an adjacent zone by a first strip 20 of RFID tags nearer to the respective zone and a second strip 20 of RFID tags farther from the respective zone. While the RFID tags are not shown in FIG. 5, they lie embedded in the floor 50 side-by-side along the dotted lines representing the first and second strips.

As an example, vehicle 14 is shown at zone A and moving in the direction of arrow 53 toward zone C. In crossing from zone A to zone C, vehicle 14 will read a RFID tag associated with strip 20a and then a RFID tag associated with adjacent strip 20b to obtain two consecutive identification numbers which can be processed to determine that vehicle 14 is crossing a boundary between zones A and C and is moving into zone C. It should be realized that vehicle will remain at zone C until zone determining information is again retrieved from RFID tags of adjacent strips, which indicates that the vehicle 14 is crossing another boundary between zone C and an adjacent zone. Additionally, regardless of the approach of the vehicle 14 across the boundary and into zone C (e.g., from zone B or D into zone C), the RFID tags are arranged such that the consecutive reads of RFID tags will identify the vehicle's movement into zone C. As indicated above with reference to FIG. 4, in alternative embodiments, a single strip of RFID tags may be used along with a heading sensor to track vehicle 14 movement between zones A-D and to identify the zone the vehicle is moving into.

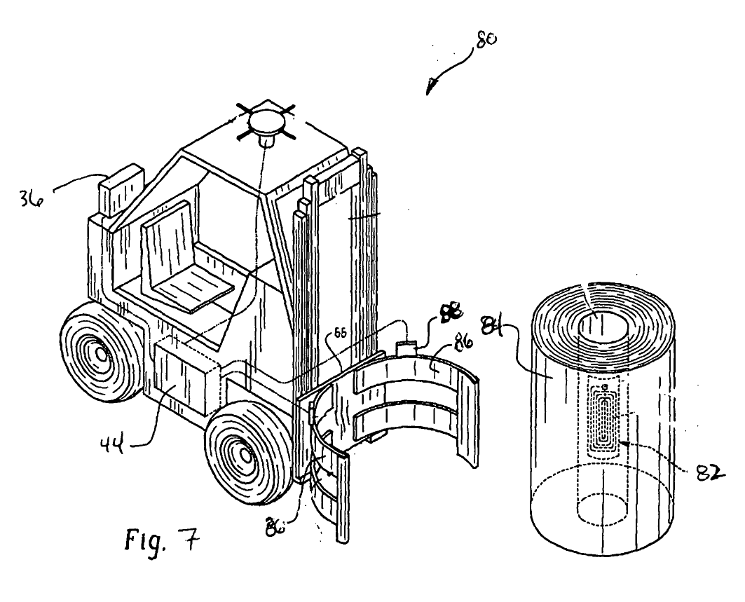

Referring now to FIG. 6, an exemplary integrated manufacturing and warehouse facility 54 is shown that utilizes one or more of the various system embodiments described above for tracking movement of inventory 56 and material handling device 58 into various zones within the facility 54. Facility 54 includes a manufacturing location 56 having a primary function of product manufacturing and a warehouse location 58 having a primary function of product storage. While the manufacturing and warehouse locations 56, 58 are depicted as being physically separate structures, they may occupy locations in a single structure. In a fashion similar to those described above, product and/or vehicle movement are tracked utilizing strips 20a, 20b and 20c of RFID tags that are fixedly disposed below the surface of the floor.

The manufacturing and warehouse facility 54 includes multiple threshold tag arrays 60, 62, 64 and 66. The threshold arrays 60, 62, 64 and 66 are each disposed at an entrance or doorway 98 providing access to spaces within the facility. Threshold array 60 is used to determine vehicle and product movement between primary storage zone 68 and temporary storage zone 70, threshold array 62 is used to determine vehicle and product movement between primary storage zone 68 and primary storage zone 72, threshold array 64 is used to determine vehicle and product movement between receiving zone 74 and at pre-production storage zone 76, and threshold array 66 is used to determine vehicle and product movement between pre-production storage zone 76 and manufacturing zone 78. Of course, other configurations are possible.

The threshold arrays 60 and 62 are further used to determine vehicle and product movement into respective regions D and B within primary storage zone 68. Primary storage zone 68 is subdivided into multiple zones A-D in a fashion similar to that described with reference to FIG. 5. By obtaining consecutive RFID tag reads from strip 20a and then strip 20b of threshold array 60 or threshold array 62, it is determined that vehicle and/or inventory is moving into zone D or zone B, respectively.

Depending on the application, various types of RFID tags 38 may be used. Tags 38 are typically classified as active or passive. A passive tag has no internal power supply and receives power from an outside source. An active tag includes an internal power source. In some applications, passive tags may be preferred due to, e.g., relatively small size and low cost. In other applications, active tags may be preferred due to relatively long transmit ranges and large memories. Tags 38 may be read-only (i.e., stored data can be read but not changed), writable (i.e., data can be added), rewritable (i.e., data can be changed or re-written), or some combination of each. Suitable, commercially available passive tags 38 may include, for example, an AD-410 single dipole tag (Class 1) available from Avery Dennison, ALN-9340-R “Squiggle™” (Class 1) available from Alien Technology Corporation, Symbol Dual Dipole (Class 0) available from Symbol Technologies, and ALL-9334-02 “2×2” Tag (Class 1) available from Alien Technology Corporation.

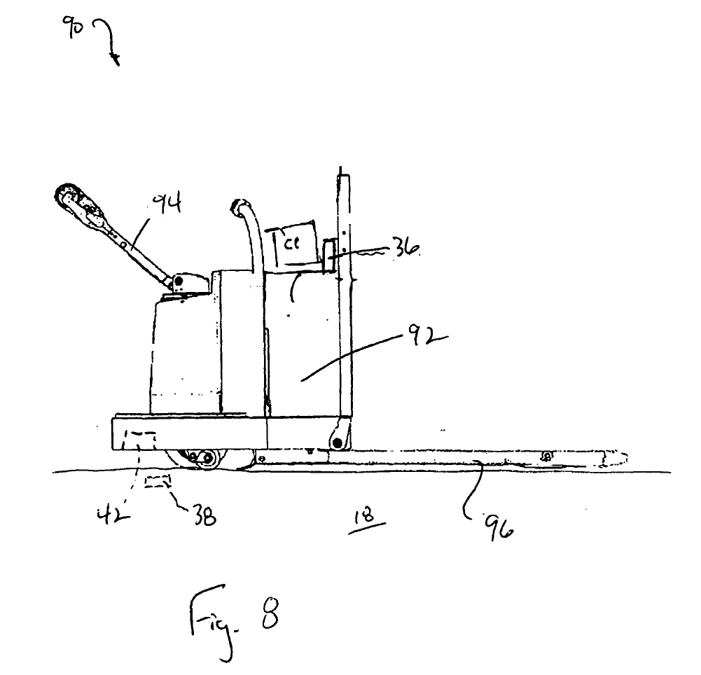

The above-described computer-assisted system can be used with a variety of inventory handling devices. For example, referring to FIG. 7, a vehicle 80 is capable of interrogating RFID tags 82 carried by inventory (e.g., a unitized load or number of shipping cases), such as a paper roll 84. In addition to components described above with reference to vehicle 14, vehicle 80 includes antenna 86 (or multiple antennas) and a reader 88 that powers RFID tag 82 so that the RFID tag communicates information stored therein to the reader 88. The reader 88 may then communicate the information obtained from the RFID tag 82 to computer 44. In some embodiments, antenna 86 may communicate with reader 36 that interrogates the floor RFID tags without any need for an additional reader 88. Material identification, manufacture date, customer and other data may be stored in the RFID tag 82. The RFID tag 82 may be written to by the reader 88 (or reader 36) to store additional information in the RFID tag 82, such as material weight. Additional details of obtaining information from product RFID tags 82 are described in U.S. patent application Ser. No. 10/305,525, entitled “System and Method for Tracking Inventory”, filed Nov. 26, 2002, the details of which are hereby incorporated by reference as if fully set forth herein.

In some embodiments, if the paper roll 58 (or other inventory unit) is moved from a first zone to a different zone, information regarding this relocation may be stored in the RFID tag 82. This product relocation information may also be stored or updated in memory accessible by the tracking system and/or warehouse management system. For example, in one embodiment, vehicle 80 may include a sensor (not shown) for use in detecting an inventory pick up and/or put down event and for responsively sending a signal to the computer 44 indicating that an inventory pick up or put down event has occurred. The sensor may, for example, be a pressure sensor that capable of monitoring pressure in a hydraulic line of the material handling mechanism. The computer 44 can process the zone determining information, the inventory unit identifications and an inventory load or unload signal to identify that the inventory unit has been placed in or picked up from a particular zone. The computer 44 can also communicate this information to a secondary computer.

Referring to FIG. 8, inventory handling device 90 (sometimes referred to as a walkie) includes a body 92, a handle 94 for use in controlling the device 90, and forks 96 for use in transporting an inventory unit. The device 90 can read the automatic identification objects in the form of RFID tags 38 that lie beneath the warehouse floor 18 along the strips 20 and 22 in a fashion similar to that described above using floor antenna 42 and reader 36. An exemplary walkie is a Yale Electric Model MPE-080-E, commercially available from Yale Materials Handling Corporation.

The systems and methods described above can be utilized to provide a number of benefits in real time, including the ability to track the location of inventory, improve warehouse utilization, improve the placement of inventory, provide independent shipment verification, and provide an electronic physical inventory. Movement of the material handling device into a particular zone can be determined without any need for determining a precise location, for example, using relatively complex location tracking systems, such as GPS. The systems and methods may be used to identify and track a variety of inventoried products for a variety of industries.

While various features of the claimed invention are presented above, it should be understood that the features may be used singly or in any combination thereof. For example, other demarcation tools may be used such as laser scanning systems, laser triangulation systems and optical triangulation systems. In some instances, it may be possible to locate the one or more strips of RFID tags overhead or to the side of the material handling device. Therefore, the claimed invention is not to be limited to only the specific embodiments depicted herein.

Further, it should be understood that variations and modifications may occur to those skilled in the art to which the claimed invention pertains. The embodiments described herein are examples of the claimed invention. The disclosure may enable those skilled in the art to make and use embodiments having alternative elements that likewise correspond to the elements of the invention recited in the claims. The intended scope of the invention may thus include other embodiments that do not differ or that insubstantially differ from the literal language of the claims. The scope of the present invention is accordingly defined as set forth in the appended claims.

What is claimed is:

1. A method of tracking inventory movement using a material handling device, the method comprising:
utilizing automatic identification objects positioned at predetermined locations about a perimeter of a zone, each automatic identification object having zone determining information that is readable by a reader;
obtaining the zone determining information from at least one automatic identification object using a reader that is carried by the material handling device;
obtaining zone determining information from a source different from the at least one automatic identification object; and
processing the zone determining information obtained from the at least one automatic identification object and the source different from the at least one automatic identification object to identify that the material handling device is moving into the zone.

2. The method of claim 1 further comprising utilizing automatic identification objects positioned at predetermined locations about perimeters of multiple zones, each automatic identification object having zone determining information that is readable by the reader.

3. The method of claim 2 further comprising
after processing the zone determining information, determining that the material handling device is in the zone until zone determining information is obtained from at least one of the automatic identification objects.

4. The method of claim 2 further comprising
obtaining zone determining information from another of the automatic identification objects using the reader that is carried by the material handling device; and
processing the zone determining information obtained from the another automatic identification object to identify that the material handling device is moving into a different zone.

5. The method of claim 1 further comprising embedding the automatic identification objects within a floor.

6. The method of claim 5, wherein the zone is substantially free of the automatic identification objects embedded in the floor.

7. The method of claim 1, wherein the automatic identification objects comprise RFID tags, the zone determining information comprising an identification number.

8. The method of claim 7, wherein the source different from the at least one automatic identification object comprises a direction determining device capable of determining direction of movement of the material handling device.

9. The method of claim 7, wherein the source different from the at least one automatic identification object is another RFID tag at a fixed location adjacent the perimeter of the zone.

10. The method of claim 1, wherein the step of processing the zone determining information obtained from the at least one automatic identification object and the source different from the at least one automatic identification object to identify that the material handling device is moving into the zone is performed without determining a precise location of the material handling device.

11. The method of claim 1, wherein the automatic identification objects are positioned side-by-side along a strip at predetermined locations about the perimeter of the zone.

12. The method of claim 11, wherein the automatic identification objects are positioned side-by-side along a first outermost strip farther from a center of the zone and a second innermost strip closer to the center of the zone.

13. The method of claim 1 further comprising obtaining item information from a RFID tag associated with an inventory item.

14. The method of claim 13, wherein the item information is obtained using the reader.

15. The method of claim 14, wherein the step of obtaining item information from the RFID tag associated with the inventory item is performed automatically in response to a triggering event detected using the material handling device with the material handling device at least partially in the zone.

16. The method of claim 15 further comprising saving zone information in memory, the zone information determined by processing the zone determining information obtained from the at least one automatic identification object and the source different from the at least one automatic identification object.

17. The method of claim 16 further comprising associating the zone information with the item information.

18. A method of tracking inventory movement using a material handling device, the method comprising:
utilizing automatic identification objects positioned at predetermined locations about a perimeter of a zone, each automatic identification object having zone determining information that is readable by a reader;
engaging an inventory unit with a power-operated mechanism of the material handling device that is configured to engage the inventory unit during a transport operation whereby the inventory unit is moved from one location to a different location, the material handling device including a reader;
obtaining the zone determining information from at least one automatic identification object using the reader;
obtaining zone determining information from a source different from the at least one automatic identification object; and
processing the zone determining information obtained from the at least one automatic identification object and the source different from the at least one automatic identification object to identify that the inventory unit is moving into the zone.

19. The method of claim 18 further comprising utilizing automatic identification objects positioned at predetermined locations about perimeters of multiple zones, each automatic identification object having zone determining information that is readable by the reader.

20. The method of claim 19 further comprising
obtaining zone determining information from another of the automatic identification objects using the reader that is carried by the material handling device; and
processing the zone determining information obtained from the another automatic identification object to identify that the inventory unit is moving into a different zone.

21. The method of claim 18 further comprising embedding the automatic identification objects within a floor.

22. The method of claim 21, wherein the zone is substantially free of the automatic identification objects embedded in the floor.

23. The method of claim 18, wherein the automatic identification objects comprise RFID tags, the zone determining information comprising an identification number.

24. The method of claim 23, wherein the source different from the at least one automatic identification object comprises a direction determining device capable of determining direction of movement of the material handling device.

25. The method of claim 23, wherein the source different from the at least one automatic identification object is another RFID tag at a fixed location adjacent the perimeter of the zone.

26. A method of tracking inventory movement using a material handling device, the method comprising:
utilizing automatic identification objects positioned at predetermined locations about perimeters of multiple zones, each automatic identification object having zone determining information that is readable by a reader;
obtaining the zone determining information from at least one automatic identification object using a reader that is carried by the material handling device;
obtaining zone determining information from a source different from the at least one automatic identification object; and
identifying the zone that the material handling device is moving into by processing the zone determining information obtained from the at least one automatic identification object and the source different from the at least one automatic identification object.

27. The method of claim 26 further comprising
after identifying the zone that the material handling device is moving into, determining that the material handling device is in the zone until zone until zone determining information is obtained from at least one of the automatic identification objects.

28. The method of claim 26 further comprising
obtaining zone determining information from another of the automatic identification objects using the reader that is carried by the material handling device; and
processing the zone determining information obtained from the another automatic identification object to identify that the material handling device is moving into a different zone.

29. The method of claim 26 further comprising embedding the automatic identification objects within a floor.

30. The method of claim 29, wherein the zones are substantially free of the automatic identification objects embedded in the floor.

31. The method of claim 26, wherein the automatic identification objects comprise RFID tags, the zone determining information comprising an identification number.

32. The method of claim 31, wherein the source different from the at least one automatic identification object comprises a direction determining device capable of determining direction of movement of the material handling device.

33. An inventory tracking system, comprising:
a plurality of zones;
a plurality of automatic identification objects positioned at predetermined locations about perimeters of the zones, each automatic identification object having zone determining information that is readable by a reader;
a material handling device including a reader configured to obtain zone determining information from the automatic identification objects; and
at least one processor that processes zone determining information obtained by the reader and zone determining information obtained from a source different from the at least one automatic identification object to determine which of the plurality of zones the material handling device is moving into.

34. The inventory tracking system of claim 33, wherein the source comprises a direction determining device capable of providing a signal to the processor indicative of the material handling device's direction of travel.

35. The inventory tracking system of claim 33, wherein the source is another automatic identification object.

36. The inventory tracking system of claim 33 further comprising an inventory item carrying at least one automatic identification object having item information that is readable by the reader.

37. A method of tracking inventory movement using a material handling device, the method comprising:
crossing a zone boundary, the zone boundary being at least partially defined by an array of automatic identification objects positioned at predetermined locations about a perimeter of a zone, each automatic identification object having zone determining information that is readable by a reader; and
processing zone determining information obtained from at least one of the automatic identification objects using a reader to determine that the reader is crossing the zone boundary into the zone;
wherein, with the reader moving into the zone, determining that the reader is moving into the zone regardless of which of the automatic identification objects zone determining information is obtained from.

38. The method of claim 37, wherein the step of processing zone determining information includes
obtaining zone determining information from a source different from the at least one of the automatic identification objects; and
processing the zone determining information obtained from the at least one of the automatic identification objects and the source to determine that the reader is crossing the zone boundary into the zone.

39. The method of claim 38, wherein the source comprises another automatic identification object.

40. The method of claim 38, wherein the source comprises a direction determining device capable of determining direction of movement of the reader.

41. The method of claim 38, wherein the automatic identification object is a RFID tag.

42. The method of claim 38, wherein the reader is mounted to the material handling device.

43. The method of claim 42 further comprising
moving an inventory unit using the material handling device; and
determining inventory movement into the zone by processing the zone determining information obtained from the at least one of the automatic identification objects using the reader.

44. A method of tracking inventory using a computer system that receives information transmitted by a material handling device, the method comprising:
utilizing automatic identification objects positioned at predetermined locations about the perimeters of multiple zones, the automatic identification objects having zone determining information;
utilizing a reader on the material handling device to read inventory information from an automatic identification object associated with an inventory unit;
transmitting the inventory information to the computer system;
as the material handling device moves into one of the zones
obtaining zone determining information from at least one automatic identification object positioned at the predetermined location using the reader;
obtaining zone determining information from a source different from the at least one automatic identification object; and
transmitting the zone determining information obtained from the at least one automatic identification object and the source different from the at least one automatic identification object to the computer system to identify that the material handling device is moving into the zone.

45. The method of claim 44 further comprising unloading the inventory unit from the material handling device in said one of the zones and transmitting an inventory unload signal to the computer system.

46. The method of claim 45 further comprising processing the zone determining information and the inventory unload signal to identify the inventory unit as being stored in said one of the zones.

47. The method of claim 45 further comprising detecting an inventory put down event using a sensor and responsively transmitting the inventory unload signal from the sensor to the computer system.

48. A method of tracking inventory movement using a material handling device, the method comprising:
a) utilizing automatic identification objects positioned at predetermined locations about a perimeter of a zone, each automatic identification object having zone determining information;
b) obtaining zone determining information from an automatic identification object using a reader carried by the material handling device;
c) obtaining zone determining information of a source different from the automatic identification object;
d) processing the zone determining information received from the automatic identification object and the source to identify that the material handling device is moving into the zone; and
e) associating a zone identifier to location of the material handling device, where the zone identifier is the same regardless of which of the automatic identification objects zone determining information is obtained from in step b with the material handling device moving into the zone.

49. The method of claim 48, wherein the source comprises another automatic identification object.

50. The method of claim 48, wherein the source comprises a direction determining device capable of determining direction of movement of the reader.

51. The method of claim 48, wherein the automatic identification object is a RFID tag.

52. The method of claim 48 further comprising embedding the automatic identification objects within a floor.

53. The method of claim 52, wherein the zone is substantially free of the automatic identification objects embedded in the floor.

54. The method of claim 53, wherein the automatic identification objects are positioned side-by-side along a strip at predetermined locations about the perimeter of the zone.

55. The method of claim 54, wherein the zone determining information is a unique identifier capable of being transmitted by the automatic identification objects.
